(19) United States
(12) Patent Application Publication
(10) Pub. No.: US 2025/0051490 A1
(43) Pub. Date: Feb. 13, 2025

(54) ROSIN MODIFIED ACRYLIC EMULSION FOR LIQUID BARRIER COATING COMPOSITIONS

(71) Applicant: BASF SE, Ludwigshafen am Rhein (DE)

(72) Inventors: Titus David LEMAN, Charlotte, NC (US); Gary DEETER, Clover, SC (US)

(21) Appl. No.: 18/718,453

(22) PCT Filed: Dec. 15, 2022
(86) PCT No.: PCT/US2022/053023

§ 371 Date: Jun. 11, 2024

Related U.S. Application Data
(60) Provisional application No. 63/290,268, filed on Dec. 16, 2021.

(51) Int. Cl. C08F 2/24; C08F 4/30; C08F 20/18; C08K 5/103; C08K 5/14; D21H 19/20

(52) U.S. Cl. CPC C08F 2/24; C08F 4/30; C08F 20/18; C08K 5/103; C08K 5/14; D21H 19/20

(57) ABSTRACT

The present disclosure provides a method of making a styrene-free polymer emulsion comprising at least one resin, wherein said resin is derived from a biorenewable source. The aqueous emulsions of the present disclosure are suitable for use in coatings.

### FIELD OF THE DISCLOSURE

The present disclosure relates generally to styrene-free multistage polymers, as well as coating compositions containing multistage polymers for use in a variety of applications.

### BACKGROUND

The Printing and Packaging market requires coating dispersions which meet the food contact requirements, have good liquid barrier performance and block resistance for functional packaging applications. Many extant coatings include styrene; however, the use of styrene for such applications has become less desirable due to possible health concerns.

An improvement in currently used coatings is needed.

### SUMMARY OF THE DISCLOSURE

The present disclosure provides a method of making a polymer emulsion comprising:
i) providing a resin dispersion comprising at least one resin in an aqueous solution;
ii) adding at least one polymer seed and a polymerization mixture to the resin dispersion, the polymerization mixture comprising at least one co-polymerizable monomer; and
iii) preparing a polymer emulsion in water by radical emulsion polymerization of the polymerization mixture, the resin dispersion and the polymer seed.

The resin may include a rosin derived from a biorenewable source, such as a fumarate ester.

The present disclosure further provides aqueous compositions and coatings of the polymer emulsions.

### DETAILED DESCRIPTION

The presently claimed invention is not to be limited in terms of the embodiments described in this application. Modifications and variations can be made without departing from its spirit and scope, as will be apparent to those skilled in the art. Functionally equivalent methods, formulations, and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to methods, reagents, compounds, or compositions, which can, of course, vary. It is also to be understood that the terminology used herein is for the purpose of describing embodiments only and is not intended to be limiting.

Furthermore, the terms “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the subject matter described herein are capable of operation in other sequences than described or illustrated herein. In case the terms “(A)”, “(B)” and “(C)” or “(a)”, “(b)”, “(c)”. “(d)”, “(i)”, “(ii)” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

For the purposes of the presently claimed invention, where features or aspects of the disclosure are described in terms of Markush groups, those skilled in the art will recognize that the disclosure is also thereby described in terms of any individual member or subgroup of members of the Markush group.

For the purposes of the presently claimed invention, all ranges disclosed herein also encompass any and all possible subranges and combinations of subranges thereof. The ranges defined throughout the specification include the end values as well, i.e. a range of 1 to 10 implies that both 1 and 10 are included in the range. For the avoidance of doubt, the applicant shall be entitled to any equivalents according to applicable law: Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to #1%, less than or equal to ±0.5%, less than or equal to ±0.2%, less than or equal to ±0.1% or less than or equal to ±0.05%. All numeric values herein are modified by the term “about,” whether explicitly indicated. A value modified by the term “about” of course includes the specific value. For instance, “about 5.0” must include 5.0.

In the following passages, different aspects of the subject matter are defined in more detail. Each aspect so defined may be combined with any other aspect or aspects unless clearly indicated to the contrary. Any feature indicated as being preferred or advantageous may be combined with any other feature or features indicated as being preferred or advantageous.

Reference throughout this specification to “one embodiment” or “an embodiment” means that a feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may refer. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the subject matter, and form different embodiments, as would be understood by those in the art. For example, in the appended claims, any of the claimed embodiments can be used in any combination.

Although the process disclosed herein has been described with reference to embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

For the purposes of the presently claimed invention, the term “polymer” refers to a single polymer or a mixture of polymers which comes about in a formation reaction from monomers to give macromolecules.

For the purposes of the presently claimed invention, “polymer emulsion” refers to an emulsion or a colloidal dispersion that comprises water-soluble and/or water-dispersible polymers.

For the purposes of the presently claimed invention, “resin dispersion” refers to a resin dispersed in water.

For the purposes of the presently claimed invention, “polymer seed” refers to polymers that act as a seed in polymerization.

For the purposes of the presently claimed invention, a surfactant is defined as a surface-active compound which decreases the surface tension of a liquid, the interfacial tension between two liquids, or that between a liquid and a solid. The term surfactant and emulsifier are interchangeable used herein.

For the purposes of the presently claimed invention, “water-soluble” means that the relevant component or ingredient of the composition can be dissolved in the aqueous phase on the molecular level.

For the purposes of the presently claimed invention, “water-dispersible” means that the relevant component or ingredient of the composition can be dispersed in the aqueous phase and forms a stable emulsion or a suspension.

For the purposes of the presently claimed invention, a binder or a solid binder is the non-volatile component of the polymer emulsion of the presently claimed invention, without pigments and fillers.

For the purposes of the presently claimed invention, the term “support resin” refers to a low molecular weight copolymer (weight average molecular weight of about 1500 g/mol to 35,000 g/mol) comprising styrene, acrylic and/or acidic monomers that can be dispersed in water upon neutralization of the acidic component.

For the purposes of the presently claimed invention, the term “aqueous” or “water-borne” as used herein refers to a significant fraction of water as the main dispersion medium besides organic solvents.

The use of (meth) in a monomer or repeat unit indicates an optional methyl group. For the purposes of the presently claimed invention, the term “copolymer” means that the copolymer comprises block or random copolymers obtainable by radical polymerization.

For the purposes of the presently claimed invention, the term “bimodal particle size distribution” as used herein refers to two different groups of particle size distribution. For the purposes of the presently claimed invention, the term “multimodal particle size distribution” as used herein refers to more than two different groups of particle size distribution.

For the purposes of the presently claimed invention, the term “surfactant-free” is intended to mean that the polymerization was conducted without the use of a surfactant, and no surfactant was added to the composition at any time prior to, or during, formation of the emulsion.

As used herein, the term “(meth)acrylate monomer” includes acrylate, methacrylate, diacrylate, and dimethacrylate monomers.

As used herein, the term “theoretical glass transition temperature” or “theoretical T_{g}” refers to the estimated T_{g} of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc. 1, 123 (1956), both of which are incorporated herein by reference. For example, the theoretical glass transition temperature of a copolymer derived from monomers a, b, . . . , and i can be calculated according to the equation below:

$$1 Tg = {w}_{a} {Tg}_{a} + {w}_{b} T {g}_{b} + … + {w}_{i} {Tg}_{i}$$

where wₐ is the weight fraction of monomer a in the copolymer, T_{ga} is the glass transition temperature of a homopolymer of monomer a, w_{b} is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

The number average molecular weight (Mn) is the statistical average molecular weight of all the polymer chains in the polymer and is defined by:

$$Mn = ( \sum NiMi ) / \sum Ni$$

where Mi is the molecular weight of a chain and Ni is the number of chains of that molecular weight.

The weight average molecular weight (Mw) is defined by:

$$Mw = ( \sum {NiMi}^{2} ) / \sum Ni$$

Compared to Mn, Mw considers the molecular weight of a chain in determining contributions to the molecular weight average. The more massive the chain, the more the chain contributes to Mw.

Higher average molecular weights (Mz) can be defined by the equation:

$$Mz = ( \sum {NiMi}^{3} ) / \sum Ni$$

The dispersity index or polydispersity index (PDI) is a measure of the distribution of molecular mass in a given polymer sample. PDI of a polymer is calculated:

$$PDI = Mw / Mn$$

where the weight average molecular weight and the statistical average molecular weight are defined above.

The term “coating” as used herein refers to any surface treatment applied to paper. The term “barrier properties” as used herein refers to an increase in resistance of paper to various materials such as air, oil, grease, and higher surface strength. The term “block resistance” as disclosed herein refers to the capability of the coating when applied to two surfaces not to stick to itself upon contact or when pressure is applied. The term “oil and/or grease resistance” as disclosed herein refers to ability of the substrate on coating to resist the formation of surface spots or stains or permeation of oil/grease through the substrate.

For the purposes of the present disclosure, paper or paperboard substrate or paper products as used herein can be any article of manufacture, at least a portion of which comprises paper coated in accordance with the presently claimed invention. The presently claimed invention encompasses paper products made of either single or multiple layers, e.g., a paper laminate, plastic laminate. The term “repulping” or “repulpability” used interchangeably herein is the ability of the coated paper or paperboard substrate to undergo the operation of re-wetting and fiberizing for subsequent paper sheet formation. The term “recycling” or “recyclability” used interchangeably herein is the ability of used treated paper and paperboard to be processed into new paper and paperboard.

The term “paper-based substrate” or “paperboard substrate” as used herein refers to any type of cellulosic fiber-based product which can folded manually or mechanically.

The present disclosure provides a method of making a polymer emulsion comprising multilayer particles. The multilayer particles may comprise a hydrophobic component and a biorenewable component. Specifically, the multilayer particles may comprise a hydrophobic core with functional groups arrayed on the surface.

The multilayer particles may be derived from acrylate monomers and a support resin. For example, the multilayer particles can range from core-shell particles to so-called “acorn” particles, wherein the second layer surrounds a substantial portion of the first layer either in a continuous, semi-continuous or discontinuous fashion (e.g., such that the second layer forms 5% or greater, 10% or greater, 15% or greater, 20% or greater, 25% or greater, 30% or less, 35% or less, 40% or less, 45% or less, or 50% or less of the particle surface). In some embodiments, the first layer and the second layer form first and second domains within the multilayer particle, wherein the second layer surrounds at least a portion of the first layer.

The biorenewable component of the multilayer particle may be about 20 wt. % or higher, about 25 wt. % or higher, about 30 wt. % or higher, about 35 wt. % or higher, about 40 wt. % or lower, about 45 wt. % or lower, about 50 wt. % or lower, 55 wt. % or lower, 60 wt. % or lower, or any value encompassed by these endpoints, as a percentage of the total particle mass.

The multilayer particles may be synthesized by combining 1) a first feed of monomers (“Feed 1”), 2) a second feed of monomers (“Feed 2”), 3) a biorenewable component, 4) a redox initiator, 4) a catalyst, and 5) a surfactant.

The present disclosure provides a process for preparing a polymer emulsion which includes the steps of providing a resin dispersion having at least one resin in water and adding at least one polymer seed and a polymerization mixture to the resin dispersion. The polymerization mixture has at least one co-polymerizable monomer. The process includes preparing a polymer emulsion in water by radical emulsion polymerization of the polymerization mixture, the resin dispersion and the polymer seed.

An aspect of the presently claimed invention relates to a process for preparing a polymer emulsion comprising at least the steps of:
i) providing a resin dispersion comprising at least one resin in an aqueous solution;
ii) adding at least one polymer seed and a polymerization mixture to the resin dispersion, the polymerization mixture comprising at least one co-polymerizable monomer; and
iii) preparing a polymer emulsion in water by radical emulsion polymerization of the polymerization mixture, the resin dispersion and the polymer seed.

An initiator may also be present in the reaction mixture. The initiator may be used to begin the polymerization process. A catalyst may also be present in the reaction mixture.

The resin may be a support resin. The resin may be derived, in whole or in part, from a biorenewable source. Suitable sources may include plants, trees, and byproducts of wood pulping processes, for example.

The biorenewable resins may include rosin esters. Suitable rosin esters may include fumarate esters, for example.

The rosin ester may have an acid value of about 125 mg KOH/g or greater, 150 mg KOH/g or greater, about 155 mg KOH/g or greater, about 160 mg KOH/g or greater, about 165 mg KOH/g or greater, about 170 mg KOH/g or greater, about 175 mg KOH/g or less, about 180 mg KOH/g or less, about 185 mg KOH/g or less, about 190 mg KOH/g or less, about 195 mg KOH/g or less, about 200 mg KOH/g or less, or any value encompassed by these endpoints.

The number average molecular weight (Mn) of the rosin ester may be about 600 g/mol or greater, about 620 g/mol or greater, about 640 g/mol or greater, about 660 g/mol or greater, about 680 g/mol or greater, about 700 g/mol or less, about 720 g/mol or less, about 740 g/mol or less, about 760 g/mol or less, about 780 g/mol or less, about 800 g/mol or less, or any value encompassed by these endpoints.

The weight average molecular weight (Mw) of the rosin ester may be about 1500 g/mol or greater, about 2000 g/mol or greater, about 2500 g/mol or greater, about 3000 g/mol or greater, about 3500 g/mol or greater, about 4000 g/mol or greater, about 4500 g/mol or less, about 5000 g/mol or less, about 5500 g/mol or less, about 6000 g/mol or less about 6500 g/mol or less, about 7000 g/mol or less, about 10,000 g/mol or less, about 15,000 g/mol or less, or any value encompassed by these endpoints.

When preparing the polymer, the rosin ester may be dispersed in an aqueous solution. Suitable aqueous solutions may include aqueous ammonia, for example. The concentration of the rosin ester in the aqueous ammonia may be about 15% or greater, about 20% or greater, about 25% or greater, about 30% or less, about 35% or less, about 40% or less, as determined either by oven (150° C., 30 min) or microwave solid analyzer.

A surfactant may then be added to the dispersion of the rosin ester in the aqueous phase. Suitable surfactants may include Disponil AFX 1080 or Calfax DB45, for example. The surfactant may be present in the reaction mixture in an amount of about 0.1 wt. % or greater, about 0.2 wt. % or greater, about 0.3 wt. % or greater, about 0.4 wt. % or greater, about 0.5 wt. % or greater, about 0.6 wt. % or less, about 0.7 wt. % or less, about 0.8 wt. % or less, about 0.9 wt. % or less, about 1 wt. % or less, or any value encompassed by these endpoints.

The emulsion may then be initiated by adding a redox initiator. Suitable redox initiators may include redox initiators, such as isoascorbic acid (IAA), t-butyl hydroperoxide (TBHP), sodium erythobate, sodium metabisulfate, or combinations thereof, for example.

The initiator may be fed to the reaction mixture over a period of about 60 minutes or greater, about 70 minutes or greater, about 80 minutes of greater, about 90 minutes or less, about 100 minutes or less, about 110 minutes or less, about 120 minutes or less, or any value encompassed by these endpoints.

The initiator may be fed to the reaction mixture at a temperature of about 60° C. or greater, about 65° C. or greater, about 70° C. or less, about 75° C. or less, about 80° C. or less, or any value encompassed by these endpoints.

A catalyst may also be added. Suitable catalysts may include copper (II) sulfate (CuSO₄) and iron (II) sulfate, for example.

The emulsion polymerization monomers may be added as two separate feeds: Feed 1 and Feed 2. Feed 1 may comprise the core of the multilayer particle. Feed 1 may comprise a hydrophobic acrylic co-polymer. Feed 1 may have a first theoretical T_{g}, which may be lower than that of Feed 2.

Feed 2 may comprise a hydrophobic acrylic co-polymer. Feed 2 may have a second theoretical T_{g}, which may be higher than that of Feed 1.

In some embodiments, the first theoretical T_{g}, as measured by DSC, can be about −30° C. or greater, about −25° C. or greater, about −24° C. or greater, about −23° C. or greater, about −22° C. or greater, about −21° C. or greater, about −20° C. or greater, about −19° C. or less, about −18° C. or less, about −17° C. or less, about −16° C. or less, about −15° C. or less, about −10° C. or less, or any value encompassed by these endpoints, as measured by ASTM D3418-15. For example, the first theoretical T_{g} may be about −25° C. to about −15° C., about −18° C. to about −10° C., about −22° C. to about −15° C., among others.

The second copolymer may have a T_{g}, as measured using DSC, of about 10° C. or greater, about 15° C. or greater, about 20° C. or greater about 25° C. or greater, about 30° C. or less, about 35° C. or less, about 40° C. or less, about 45° C. or less, about 50° C. or less, or any value encompassed by these endpoints, such as 20° C. to 40° C., 10° C. to 25° C., 30° C. to 50° C., among others.

In some embodiments, the multistage polymer (or the multilayer particle) exhibits a single T_{g}, measured using differential scanning calorimetry (DSC), of 0° C. or greater, about 1° C. or greater, about 2° C. or greater, about 3° C. or greater, about 4° C. or greater, about 5° C. or greater, about 6° C. or less, about 7° C. or less, about 8° C. or less, about 9° C. or less, about 10° C. or less, or any value encompassed by these endpoints. The glass transition temperature can be determined by differential scanning calorimetry (DSC) by measuring the midpoint temperature using ASTM D 3418-12e1.

In some embodiments, Feed 1 may include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

Feed 1 may comprise one or more soft ethylenically-unsaturated monomers, as well as one or more hard ethylenically-unsaturated monomers.

As used herein, the term “soft ethylenically-unsaturated monomer” refers to an ethylenically-unsaturated monomer that, when homopolymerized, forms a polymer having a glass transition temperature, as measured using differential scanning calorimetry (DSC), of 0° C. or less. Soft ethylenically-unsaturated monomers are known in the art, and include, for example, ethyl acrylate (T_{g}=−24° C.), butyl acrylate (n-butyl acrylate, T_{g}=−54° C.), sec-butyl acrylate (T_{g}==26° C.), sec-butyl acrylate (T_{g}=−26° C.), isobutyl acrylate (T_{g}=−24° C.), n-hexyl acrylate (T_{g}==45° C.), n-hexyl methacrylate (T_{g}==5° C.), 2-ethylhexyl acrylate (T_{g}=−85° C.), 2-ethylhexyl methacrylate (T_{g}=−10° C.), octyl methacrylate (T_{g}=−20° C.), n-decyl methacrylate (T_{g}=−30° C.), isodecyl acrylate (T_{g}=−55° C.), dodecyl acrylate (T_{g}==3° C.), dodecyl methacrylate (T_{g}=−65° C.), 2-ethoxyethyl acrylate (T_{g}=−50° C.), 2-methoxy acrylate (T_{g}=−50° C.), and 2-(2-ethoxyethoxy)ethyl acrylate (T_{g}=−70° C.).

In some embodiments, Feed 1 may comprise a soft ethylenically-unsaturated monomer that, when homopolymerized, forms a polymer having a glass transition temperature, as measured using DSC, about −30° C. or greater, about −25° C. or greater, about −24° C. or greater, about −23° C. or greater, about −22° C. or greater, about −21° C. or greater, about −20° C. or greater, about −19° C. or less, about −18° C. or less, about −17° C. or less, about −16° C. or less, about −15° C. or less, about −10° C. or less, or any value encompassed by these endpoints, as measured by ASTM D3418-15. For example, the first theoretical T_{g} may be about −25° C. to about −15° C., about −18° C. to about −10° C., about −22° C. to about −15° C., among others.

In certain embodiments, the soft ethylenically-unsaturated monomer can be a (meth)acrylate monomer. In certain embodiments, Feed 1 may comprise a soft ethylenically-unsaturated monomer selected from the group consisting of butyl acrylate, 2-ethylhexyl acrylate, and combinations thereof.

Feed 1 may comprise at least 50% by weight of one or more soft ethylenically-unsaturated monomers, based on the total weight of the monomers used in Feed 1 (e.g., at least 50% by weight, at least 55% by weight, at least 60% by weight, at least 65% by weight, at least 70% by weight, at least 75% by weight, or at least 80% by weight, at least 85% by weight, at least 90% by weight, at least 95% by weight, at least 97% by weight, at least 99% by weight, or at least 99.9% by weight).

Feed 1 may comprise an amount of one or more soft ethylenically-unsaturated monomers ranging from any of the percentages described above to any other of the percentages described above. For example, Feed 1 may comprise from 50% to 99.9% by weight of one or more soft ethylenically-unsaturated monomers, based on the total weight of the monomers used (e.g., from 90% to 97% by weight, from 50% to 85% by weight, from 70% to 99% by weight, for example).

Exemplary acrylate and methacrylate monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxy cyclohexylmethyl (meth)acrylate, 1,6 hexanediol di(meth)acrylate, 1,4 butanediol di(meth)acrylate, and combinations thereof. In some embodiments, Feed 1 may comprise one or more acrylate monomers selected from the group consisting of methyl methacrylate, butyl acrylate, and 2-ethylhexyl acrylate.

Feed 1 may comprise a hard ethylenically unsaturated monomer. Suitable hard ethylenically unsaturated monomers may include methyl methacrylate, T_{g}=125° C.

The methyl methacrylate may be present in the composition in an amount of about 30 wt. % or greater, about 35 wt. % or greater, about 40 wt. % or less, about 45 wt. % or less, about 50 wt. % or less, or any value or range encompassed by these endpoints, based on the total weight of monomers used, for example from 30 to 50 wt. %, or from 35 to 45 wt. %.

Feed 1 may comprise one or more carboxylic acid-containing monomers based on the total weight of monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

Feed 1 may comprise from 0% by weight or greater of one or more carboxylic acid-containing monomers, based on the total weight of the monomers used (e.g., at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight). Feed 1 may comprise from 5% or less by weight of one or more carboxylic acid-containing monomers, based on the total weight of the monomers used (e.g., from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

Feed 1 may comprise an amount of one or more carboxylic acid-containing monomers ranging from any of the minimum percentages described above to any of the maximum percentages described above. For example, Feed 1 may comprise from 0% by weight to 5% by weight of one or more carboxylic acid-containing monomers, based on the total weight of the monomers used (e.g., from 0% by weight to 2.5% by weight of one or more carboxylic acid-containing monomers). In certain embodiments, Feed 1 may comprise from 0% by weight to 5% by weight (e.g., 0% by weight to 3% by weight, 0% by weight to 2.5% by weight, or 0% by weight to 1.5% by weight) itaconic acid.

Feed 1 may be substantially free of styrene. In other words, the amount of styrene in Feed 1 may be 1 wt. % or less, 0.5 wt. % or less, 0.1 wt. % or less, or 0 wt. %.

Feed 2 may form a homopolymer derived from a single ethylenically-unsaturated monomer or a copolymer derived from ethylenically-unsaturated monomers. In some embodiments, Feed 2 may include an acrylic-based polymer. Acrylic-based polymers include polymers derived from one or more (meth)acrylate monomers. In certain embodiments, the polymer formed from Feed 2 may have ethylenically unsaturated bonds.

Feed 2 may comprise one or more ethylenically-unsaturated monomers. As used herein, the term “ethylenically-unsaturated monomer” refers to an ethylenically-unsaturated monomer that, when homopolymerized, forms a polymer having a T_{g}, as measured using DSC, of greater than 0° C. Ethylenically-unsaturated monomers are known in the art, and include, for example, methyl acrylate (T_{g}=10° C.), methyl methacrylate (T_{g}=120° C.), ethyl methacrylate (T_{g}=65° C.), butyl methacrylate (T_{g}−20° C.), tert-butyl methacrylate (T_{g}=118° C.), isobutyl methacrylate (T_{g}=53° C.), vinyl acetate (T_{g}=30° C.), hydroxyethyl acrylate (T_{g}=15° C.), hydroxyethyl methacrylate (T_{g}=57° C.), cyclohexyl acrylate (T_{g}=19° C.), cyclohexyl methacrylate (T_{g}=92° C.), 2-ethoxyethyl methacrylate (T_{g}=16° C.), 2-phenoxyethyl methacrylate (T_{g}=54° C.), benzyl acrylate (T_{g}=6° C.), benzyl methacrylate (T_{g}=54° C.), hydroxypropyl methacrylate (T_{g}=76° C.), styrene (T_{g}=100° C.), acrylamide (T_{g}=165° C.), acrylonitrile (T_{g}=125° C.), n-tert-butylacrylamide (T_{g}=128° C.), isobornyl acrylate (T_{g}−94° C.), isobornyl methacrylate (T_{g}=110° C.), and combinations thereof.

In some embodiments, Feed 2 may comprise one or more ethylenically-unsaturated monomers that, when homopolymerized, form a polymer having a T_{g}, as measured using DSC, of at least 80° C. (e.g., at least 85° C., at least 90° C., at least 95° C., at least 100° C., at least 105° C., at least 110° C., at least 115° C., or at least 120° C.).

In some embodiments, Feed 2 may comprise from greater than 50% by weight or greater of one or more ethylenically-unsaturated monomers (e.g., 65% by weight or greater, 75% by weight or greater, 80% by weight or greater, 85% by weight or greater, 88% by weight or greater, 90% by weight or greater, 91% by weight or greater, 92% by weight or greater, 93% by weight or greater, 94% by weight or greater, or 95% by weight or greater of the ethylenically-unsaturated monomer) based on the total weight of monomers used.

In some embodiments, Feed 2 may comprise one or more ethylenically-unsaturated monomers selected from the group consisting of methyl methacrylate, butyl acrylate, and 2-ethylhexyl acrylate, and combinations thereof. In certain embodiments, Feed 2 may comprise from at least 10% by weight (e.g., at least 10% by weight, at least 20% by weight, at least 30% by weight, at least 40% by weight, at least 50% by weight, at least 60% by weight, at least 70% by weight, at least 80% by weight, at least 90% by weight, at least 92% by weight, at least 95% by weight, at least 96% by weight, at least 97% by weight, or at least 98% by weight) of one or more ethylenically-unsaturated monomers selected from the group consisting of methyl methacrylate, butyl acrylate, and 2-ethylhexyl acrylate, and combinations thereof, based on the total weight of monomers used.

Feed 2 may be substantially free of styrene. In other words, the amount of styrene in Feed 2 may be 1 wt. % or less, 0.5 wt. % or less, 0.1 wt. % or less, or 0 wt. %.

In addition to the ethylenically-unsaturated monomers, Feed 2 may also comprise one or more ethylenically unsaturated acid monomers.

In some embodiments, Feed 2 may comprise one or more carboxylic acid-containing monomers based on the total weight of monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

Feed 2 may comprise from 0% by weight or greater of one or more carboxylic acid-containing monomers, based on the total weight of the monomers used (e.g., at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight). Feed 2 may comprise 5% or less by weight of one or more carboxylic acid-containing monomers, based on the total weight of the monomers used (e.g., from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

Feed 2 may comprise an amount of one or more carboxylic acid-containing monomers ranging from any of the minimum percentages described above to any of the maximum percentages described above. For example, Feed 2 may comprise from 0% by weight to 5% by weight of one or more carboxylic acid-containing monomers, based on the total weight of the monomers used (e.g., from 0% by weight to 2.5% by weight of one or more carboxylic acid-containing monomers). In certain embodiments, Feed 2 may comprise from 0% by weight to 5% by weight (e.g., 0% by weight to 3% by weight, 0% by weight to 2.5% by weight, or 0% by weight to 1.5% by weight) itaconic acid.

The copolymer formed from Feed 2 may have an acid content of about 5 wt. % or less, about 4 wt. % or less, about 3 wt. % or less, about 2 wt. % or less, about 1 wt. % or less, about 0.5 wt. % or less, or any value encompassed by these endpoints, based on the total weight of the second copolymer.

The weight ratio of the first copolymer to the second copolymer in the multistage particle may be in a range of from 50:50 to 75:25, such as 50:50, 60:40, 70:30, 75:25, or any value encompassed by these endpoints.

The monomers of Feed 2 may be present in the multistage particle in an amount of about 2.5 wt. % or greater, about 5 wt. % or greater, about 10 wt. % or greater, about 15 wt. % or greater, about 20 wt. % or less, about 25 wt. % or less, about 30 wt. % or less, about 35 wt. % or less, about 40 wt. % or less, or any value encompassed by these endpoints, such as about 2.5 wt. % to about 40 wt. %, about 10 wt. % to about 25 wt. %, about 5 wt. % to about 15 wt. %, or about 35 wt. % to about 40 wt. %, for example, based on the total particle weight.

In certain embodiments, the emulsion polymerization monomers may comprise a mixture of methyl methacrylate, butyl acrylate, 2-ethylhexyl acrylate, and additional functional monomers, such as acrylic acid, methyl acrylic acid, and/or itaconic acid.

In certain embodiments, the amount of methyl methacrylate monomers present in the emulsion polymerization mixture may be about 40 wt. % or greater, about 41 wt. % or greater, about 42 wt. % or greater, about 43 wt. % or greater, about 44 wt. % or greater, about 45 wt. % or greater, about 46 wt. % or less, about 47 wt. % or less, about 48 wt. % or less, about 49 wt. % or less, about 50 wt. % or less, or any value encompassed by these endpoints, as a percentage of the total emulsion polymerization mixture.

In certain embodiments, the amount of butyl acrylate monomers present in the emulsion polymerization mixture may be about 30 wt. % or greater, about 31 wt. % or greater, about 32 wt. % or greater, about 33 wt. % or greater, about 34 wt. % or greater, about 35 wt. % or greater, about 36 wt. % or less, about 37 wt. % or less, about 38 wt. % or less, about 39 wt. % or less, about 40 wt. % or less, or any value encompassed by these endpoints, as a percentage of the total emulsion polymerization mixture.

In certain embodiments, the amount of 2-ethylhexyl acrylate monomers present in the emulsion polymerization mixture may be about 5 wt. % or greater, about 10 wt. % or greater, about 15 wt. % or greater, about 20 wt. % or less, about 25 wt. % or less, about 30 wt. % or less, or any value encompassed by these endpoints, as a percentage of the total emulsion polymerization mixture.

In certain embodiments, the emulsion polymerization mixture may include one or more functional monomers. The functional monomers may include one or more of acrylic acid monomers, methyl acrylic acid monomers, and itaconic acid monomers. The functional monomers may be present in the emulsion polymerization mixture in an amount of 0 wt. % or greater, about 0.1 wt. % or greater, about 0.2 wt. % or greater, about 0.3 wt. % or greater, about 0.4 wt. % or greater, about 0.5 wt. % or greater, about 0.6 wt. % or greater, about 0.7 wt. % or greater, about 0.8 wt. % or greater, about 0.9 wt. % or greater, about 1.0 wt. % or less, about 1.1 wt. % or less, about 1.2 wt. % or less, about 1.3 wt. % or less, about 1.4 wt. % or less, about 1.5 wt. % or less, about 1.6 wt. % or less, about 1.7 wt. % or less, about 1.8 wt. % or less, about 1.9 wt. % or less, about 2.0 wt. % or less, or any value encompassed by these endpoints, as a percentage of the total emulsion polymerization mixture.

Feeds 1 and 2 may be fed to the reaction mixture over a period of about 60 minutes or greater, about 70 minutes or greater, about 80 minutes of greater, about 90 minutes or less, about 100 minutes or less, about 110 minutes or less, about 120 minutes or less, or any value encompassed by these endpoints.

Feeds 1 and 2 may be fed to the reaction mixture at a temperature of about 60° C. or greater, about 65° C. or greater, about 70° C. or less, about 75° C. or less, about 80° C. or less, or any value encompassed by these endpoints.

The weight ratio of Feed 1 to Feed 2 monomers may be about 50:50 or greater, about 55:45 or greater, about 60:40 or greater, about 65:35 or less, about 70:30 or less, about 75:25 or less, about 80:20 or less, or any value encompassed by these endpoints.

In certain embodiments, a surfactant may be present. Suitable surfactants may include Aerosol OT75, for example. The amount of surfactant present in the emulsion polymerization mixture may include 0 wt. % or greater, about 0.1 wt. % or greater, about 0.2 wt. % or greater, about 0.3 wt. % or greater, about 0.4 wt. % or greater, about 0.5 wt. % or greater, about 0.6 wt. % or greater, about 0.7 wt. % or greater, about 0.8 wt. % or greater, about 0.9 wt. % or greater, about 1.0 wt. % or less, about 1.1 wt. % or less, about 1.2 wt. % or less, about 1.3 wt. % or less, about 1.4 wt. % or less, about 1.5 wt. % or less, about 1.6 wt. % or less, about 1.7 wt. % or less, about 1.8 wt. % or less, about 1.9 wt. % or less, about 2.0 wt. % or less, or any value encompassed by these endpoints, as a percentage of the total emulsion polymerization mixture.

The average diameter of the multilayer particles may be about 100 nm or greater, about 150 nm or greater, about 200 nm or greater, about 250 nm or greater, about 300 nm or greater, about 350 nm or less, about 400 nm or less, about 450 nm or less, about 500 nm or less, about 550 nm or less, about 600 nm or less, or any value encompassed by these endpoints, as determined by dynamic light scattering.

The solids content of the emulsion may be about 25% or greater, about 30% or greater, about 35% or greater, about 40% or less, about 45% or less, about 48% or less, about 50% or less, or any value encompassing these endpoints.

The pH of the emulsion may be about 7.5 or higher, about 7.6 or higher, about 7.7 or higher, about 7.8 or higher, about 7.9 or higher, about 8.0 or higher, about 8.1 or higher, about 8.2 or lower, about 8.3 or lower, about 8.4 or lower, about 8.5 or lower, about 8.6 or lower, about 8.7 or lower, about 8.8 or lower, about 8.9 or lower, about 9.0 or lower, or any value encompassing these endpoints.

The emulsion may be substantially free of grit. In other words, the amount of grit in the emulsion may be about 1% or less, about 0.9% or less, about 0.8% or less, about 0.7% or less, about 0.6% or less, about 0.5% or less, about 0.4% or less, about 0.3% or less, about 0.2% or less, or about 0.1% or less. The amount of grit may be determined by filtering 100 grams of the emulsion using a 125 or 45-micron filter, flushing with water, drying in an oven, and then weighing the amount of grit.

The emulsion may be stable under storage conditions. The stability of the emulsion may be determined by measuring, among other factors, the amount of coagulation present following a period of storage. The degree of coagulation may be determined by analysis of molecular weights following the storage period, as further described in the Examples below. The stability of the emulsion may also be determined by measuring the acid value following the storage period, as further described in the Examples below.

A suitable testing period may be about 1 week or more, about 2 weeks or more, about 3 weeks or more, about 4 weeks or more, or about 5 weeks or more, for example. The temperature during the storage testing period may be about 50° C., for example.

Also provided are aqueous compositions comprising one or more of the multistage polymers (or multilayer particles) described above. The aqueous compositions can further include one or more additives, including pigments, fillers, dispersants, coalescents, defoamers, surfactants, thickeners, biocides, and combinations thereof. The choice of additives in the composition will be influenced by a number of factors, including the nature of the multistage polymers (or multilayer particles) dispersed in the aqueous composition, as well as the intended use of the composition. In some cases, the composition can be, for example, a coating composition, including a food-safety compliant coating composition. In some embodiments, the composition comprises less than or equal to 50 grams per liter of volatile organic compounds.

The aqueous composition may comprise greater than 40% solids, such as about 40% or greater, about 50% or greater, about 55% or greater, about 60% or greater, about 65% or greater, or about 70% or greater.

In some embodiments, the aqueous composition can further comprise one or more surfactants. Suitable surfactants may include Disonil A1080, Calfax DB45, Dowfax 2A-1, Aeorosol OT 75 (sodium dioctyl sulfosuccinate), and combinations thereof, for example.

The composition can include 0% by weight or greater of one or more surfactants, based on the total weight of all components of the aqueous composition (e.g., 0% by weight, at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, or at least 9.5% by weight). The composition can include 10% or less of one or more surfactants, based on the total weight of all components of the aqueous composition (e.g., from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

The composition can include one or more surfactants in an amount ranging from any of the minimum percentages described above to any of the maximum percentages described above. For example, the composition can include from 0% by weight to 10% by weight of one or more surfactants, based on the total weight of all components of the aqueous composition (e.g., from 0% by weight to 3% by weight of one or more surfactants, from 0% by weight to 2.5% by weight of one or more surfactants, from 0% by weight to 1.5% by weight of one or more surfactants, or 0% by weight to 1% by weight of one or more surfactants). In some embodiments, the composition is substantially free (i.e., the composition includes 0.1% or less by weight) of surfactants.

Examples of suitable pigments include metal oxides, such as titanium dioxide, zinc oxide, iron oxide, or combinations thereof. In certain embodiments, the composition includes a titanium dioxide pigment. Examples of commercially titanium dioxide pigments are KRONOS® 2101. KRONOS® 2310, available from Kronos WorldWide, Inc. (Cranbury, N.J.), TI-PURE® R-900, available from DuPont (Wilmington, Del.), or TIONA® ATI commercially available from Millenium Inorganic Chemicals. Titanium dioxide is also available in concentrated dispersion form. An example of a titanium dioxide dispersion is KRONOSR 4311, also available from Kronos WorldWide, Inc.

Examples of suitable fillers include calcium carbonate, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler.

Examples of suitable dispersants are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE. Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Defoamers serve to minimize frothing during mixing and/or application of the coating composition. Suitable defoamers include silicone oil defoamers, such as polysiloxanes, polydimethylsiloxanes, polyether modified polysiloxanes, and combinations thereof. Exemplary silicone-based defoamers include BYKR-035, available from BYK USA Inc. (Wallingford. Conn.), the TEGO® series of defoamers, available from Evonik Industries (Hopewell. Va.), and the DREWPLUS® series of defoamers, available from Ashland Inc. (Covington. Ky.).

Suitable surfactants include nonionic surfactants and anionic surfactants. Examples of nonionic surfactants are alkylphenoxy polyethoxyethanols having alkyl groups of about 7 to about 18 carbon atoms, and having from about 6 to about 60 oxyethylene units: ethylene oxide derivatives of long chain carboxylic acids: analogous ethylene oxide condensates of long chain alcohols, and combinations thereof, Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE, In certain embodiments, the composition comprises an anionic alkyl ether sulfate surfactant, In certain embodiments, the composition comprises an anionic diphenyl oxide disulfonate surfactant, such as CALFAX® DB-45, commercially available from Pilot Chemical, In some embodiments, the composition comprises an anionic surfactant, such as Aeorosol OT75. In some embodiments, the composition is substantially free (i.e., the composition includes 0.1% or less by weight) of sulfate surfactants. In some embodiments, the composition is substantially free (i.e., the composition includes 0.1% or less by weight) of sulfonate surfactants. In some embodiments, the composition is substantially free (i.e., the composition includes 0.1% or less by weight) of sulfate surfactants and sulfonate surfactants.

Suitable biocides can be incorporated to inhibit the growth of bacteria and other microbes in the coating composition during storage. Exemplary biocides include 2-[(hydroxymethyl)amino]ethanol, 2-[(hydroxymethyl)amino]2-methyl-1-propanol. o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio) benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Other suitable additives that can optionally be incorporated into the composition include rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, crosslinking agents, flatting agents, flocculants, humectants, insecticides, lubricants, odorants, oils, waxes and slip aids, soil repellants, stain resisting agents, and combinations thereof.

Coating compositions can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The coating compositions can be applied to a variety of surfaces including, but not limited to paper, paperboard, and cardboard, for example.

Also provided are coatings formed from the coating compositions described herein. Generally, coatings are formed by applying a coating composition described herein to a surface, and allowing the coating to dry to form a coating. The coating thickness can vary depending upon the application of the coating.

An aspect of presently claimed invention is directed to a substrate comprising at least one surface coated with at least one layer comprising an aqueous composition disclosed herein. In an embodiment of the presently claimed invention, the substrate is paper or paperboard.

The aqueous compositions disclosed herein can be used with any substrate to impart water, moisture, grease, oil, and/or oxygen resistance. In an embodiment of the presently claimed invention, the substrate can be a cellulose-based substrate, such as paper, paper board, or cardboard. The cellulose-based substrates can include paper cups, including for instance, disposable or recyclable paper cups, paper bags for dry foods, such as, for example, coffee, tea, soup powders, sauce powders; for liquids, such as, for example, cosmetics, cleaning agents, beverages; of tube laminates; of paper carrier bags; of paper laminates and co-extrudates for ice cream, confectionery (e.g., chocolate bars and muesli bars), of paper adhesive tape; of cardboard cups (e.g., paper cups), yogurt pots, souffle cups; of meal trays, or meat trays; of wound cardboard containers (e.g., cans, drums), of wet-strength cartons for outer packaging (e.g., wine bottles, food); of fruit boxes of coated cardboard; of fast food plates; of clamp shells; of beverage cartons and cartons for liquids, such as detergents and cleaning agents, frozen food cartons, ice packaging (e.g., ice cups, wrapping material for conical ice cream wafers); of paper labels; or of flower pots and plant pots.

Another aspect of the presently claimed invention is directed to a coated paper or an article comprising the aqueous composition disclosed herein. In an embodiment of presently claimed invention, the coated paper or an article comprising the aqueous composition disclosed herein has a coating weight in the range of from about 2 g/m² to about 30 g/m² of the coated paper. In an embodiment of presently claimed invention, the coated paper or an article comprising the aqueous composition disclosed herein has a coating weight in the range of from about 10 g/m² to about 25 g/m² of the coated paper. In another embodiment of the presently claimed invention, the coated paper has a block resistance of 3 or greater for 24 hours at 60° C. and 60 psi determined according to ASTM WK20008. In another embodiment of the presently claimed invention, the coated paper has a block resistance of 4 or greater for 24 hours at 60° C. and 60 psi determined according to ASTM WK20008. In a yet another embodiment of the presently claimed invention, the paper exhibits oil and/or grease resistant properties.

Another aspect of the presently claimed invention is directed to a method of making paper comprising at least the step of contacting a cellulosic fiber with an aqueous composition disclosed herein. In an embodiment of the presently claimed invention, the step of contacting the cellulosic fiber with the aqueous composition comprises coating a paper web comprising a cellulosic fiber with an aqueous dispersion comprising the aqueous composition. In another embodiment of the presently claimed invention, contacting the cellulosic fiber with the aqueous composition disclosed herein comprises (i) mixing an aqueous dispersion comprising the aqueous composition with the cellulosic fibers to form a slurry; and (ii) forming a paper web from the slurry of the cellulosic fibers and the aqueous composition.

In another embodiment of the presently claimed invention, the aqueous composition is coated on the substrate. For example, the aqueous composition can be provided as a coating on a paper web. The aqueous composition can have a coating weight of 2 g/m² or greater, for e.g., 3 g/m² or greater, 4 g/m² or greater, 5 g/m² or greater, 6 g/m² or greater, 7 m² or greater, 8 g/m² or greater, 9 g/m² or greater, 10 g/m² or greater, 11 g/m² or greater, 12 g/m² or greater, 13 g/m² or greater, 14 g/m² or greater, 15 g/m² or greater, 16 g/m² or greater, 17 g/m² or greater, 18 g/m² or greater, 19 g/m² or greater, 20 g/m² or greater, 21 g/m² or greater, 22 g/m² or greater, 23 g/m² or greater, 24 g/m² or greater, 25 g/m² or greater, 26 g/m² or greater, 27 g/m² or greater, 28 g/m² or greater, or 29 g/m² or greater. In an embodiment of the presently claimed invention, the aqueous composition can have a coating weight of 30 g/m² or less, for e.g., 29 g/m² or less, 28 g/m² or less, 27 g/m² or less, 26 g/m² or less, 25 g/m² or less, 24 g/m² or less, 23 g/m² or less, 22 g/m² or less, 21 g/m² or less, 20 g/m² or less, 19 g/m² or less, 18 g/m² or less, 17 g/m² or less, 16 g/m² or less, g/m² or less, 14 g/m² or less, 13 g/m² or less, 12 g/m² or less, 11 g/m² or less, 10 g/m² or less, 9 g/m² or less, 8 g/m² or less, 7 g/m² or less, 6 g/m² or less, 5 g/m² or less, 4 g/m² or less, or 3 g/m² or less. In yet another embodiment of the presently claimed invention, the aqueous composition can have a coating weight of from 2 g/m² to 30 g/m², for e.g., 3 g/m² to 30 g/m², 4 g/m² to 30 g/m², 5 g/m² to 30 g/m², or 10 g/m² to 25 g/m². The coating weight can be reported in units of grams of coating per square meter of cellulose-based substrate and can be calculated directly by the amount of coating applied and the surface area of the cellulose-based substrate that the coating is applied to. In an embodiment of the presently claimed invention, the aqueous-composition can be applied in an amount of less than 15 wt. % based on the weight of the coated cellulose-based substrate. In some embodiments, the aqueous composition can be from 0.01 wt. % to 5 wt. %, for e.g., from 0.1 wt. % to 5 wt. %, from 0.5 wt, % to 5 wt. %, from 0.1 wt. % to 4 wt. %, from 0.1 wt. % to 3 wt. %, from 0.1 wt. % to 2.5 wt. %, or 0.1 wt. % or greater, 0.5 wt. % or greater, 1 wt. % or greater, 1.5 wt. % or greater, by weight of the substrate.

In an embodiment of the presently claimed invention, the aqueous composition can have a thickness of from 0.40 mils or greater, for e.g., 0.5 mils or greater, 0.6 mils or greater, 0.7 mils or greater, 0.8 mils or greater, 0.9 mils or greater, 1 mils or greater, 1.1 mils or greater, 1.2 mils or greater, 1.3 mils or greater, 1.4 mils or greater, 1.5 mils or greater, 1.6 mils or greater, 1.7 mils or greater, 1.8 mils or greater, 1.9 or greater. In an embodiment of the presently claimed invention, the aqueous composition can have a thickness of 2 mils or less, for e.g., 1.9 mils or less, 1.8 mils or less, 1.7 mils or less, 1.6 mils or less, 1.5 mils or less, 1.4 mils or less, 1.3 mils or less, 1.2 mils or less, 1 mils or less, 0.9 mils or less, 0.8 mils or less, 0.7 mils or less, 0.6 mils or less, or 0.5 mils or less. The aqueous composition can have, in some embodiments, a thickness of from 0.4 mils to 2 mils, for e.g., from 0.5 mils to less than 1.8 mils, from 0.6 mils to 1.6 mils, or from 0.7 mils to 1.5 mils. The coating thickness can be calculated based on the density of the coating and the weight of the coated cellulose-based substrate.

In an embodiment of the presently claimed invention, a coating is provided with the aqueous composition. In another embodiment of the presently claimed invention, the coating can be on one or more surfaces of the substrate. For purposes of the presently claimed invention, the substrate also refers to paper cups or paper bags. The paper cup can have an interior surface, an exterior surface, a bottom portion, and a side portion. The aqueous composition can be on a first surface and/or a second surface of the paper cup. The first surface may comprise one or more of an interior surface of the side portion and/or an interior surface of the bottom portion. In some embodiments, only a portion, for e.g., 10% or greater, 20% or greater, 30% or greater, 40% or greater, 50% or greater, 60% or greater, 70% or greater, 80% or greater, 90% or greater, or all of the interior surface is coated. In an embodiment of the presently claimed invention, the entire interior surface is coated. In an embodiment of the presently claimed invention, the second surface, comprises one or more of an exterior surface of the side portion and/or an exterior surface of the bottom portion. In another embodiment of the presently claimed invention, only a portion, for e.g., 10% or greater, 20% or greater, 30% or greater, 40% or greater, 50% or greater, 60% or greater, 70% or greater, 80% or greater, 90% or greater, or all of the exterior surface is coated. In yet another embodiment of the presently claimed invention, the entire exterior surface is coated.

The aqueous composition can be coated onto a cellulose-based substrate using a paper machine in a mill or by a printing method.

In an embodiment of the presently claimed invention, the aqueous composition is provided throughout the substrate, for example, a paper web formed of cellulosic fibers. In yet another embodiment of the presently claimed invention, the aqueous composition can be from 4 wt. % to 30 wt. % by weight of the substrate, for e.g., from 5 wt. % to 30 wt. %, from 5 wt. % to 29 wt. %, from 5 wt. % to 28 wt. %, from 5 wt. % to 27 wt. %, from 5 wt. % to 26 wt. %, from 5 wt. % to 20 wt. %, or 4 wt. % or greater, 5 wt. % or greater, 6 wt. % or greater, 7 wt. % or greater, 8 wt. % or greater, 9 wt. % or greater, or 10 wt. % or greater, in each case based on the weight of the substrate.

The aqueous composition can be added to a substrate, such as a cellulose-based substrate using any method known in the art for adding the aqueous composition to a substrate. In an embodiment of the presently claimed invention, the method can include coating a paper web comprising cellulosic fibers with an aqueous dispersion comprising the aqueous composition. In another embodiment of the presently claimed invention, the method can include spraying an aqueous dispersion comprising the aqueous composition on a paper web. In yet another embodiment of the presently claimed invention, the method can include mixing an aqueous dispersion comprising the aqueous composition with an aqueous slurry comprising the cellulosic fibers to form a mixture and forming a paper web form the mixture of the cellulosic fibers and the aqueous composition.

In an embodiment of the presently claimed invention, the aqueous composition can impart water, moisture, grease, oil, and/or oxygen resistance to the substrate compared to applications that do not include the aqueous composition. The substrates may also exhibit reduced or eliminated leaks or staining. Liquid-water and water-vapor resistance of a substrate comprising the aqueous composition can be tested with the Cobb method, described by TAPPI T 441 (2001), which is incorporated by reference herein in its entirety. This method determines the amount of liquid water or moisture vapor absorbed by paper, paperboard, and corrugated fiberboard in a specified time under standardized conditions. In an embodiment of the presently claimed invention, the coated substrates described herein would pass the water-resistance test set forth in this test method. Water absorptiveness can be a function of various characteristics of paper or paperboard including, but are not limited to, sizing and porosity.

In an embodiment of the presently claimed invention, over a period of 30 minutes, the substrate comprising the aqueous composition can exhibit a Cobb value of about 10 g/m² or greater, about 12 g/m² or greater, about 14 g/m² or greater, about 16 g/m² or greater, about 18 g/m² or greater, about 20 g/m² or less, about 22 g/m² or less, about 24 g/m² or less, about 26 g/m² or less, about 30 g/m² or less, or any value encompassed by these endpoints, as determined by Tappi T441.

Further, the substrate comprising the aqueous composition described herein may exhibit minimal tendencies of blocking, i.e., the adhesion of the coated surface to another coated surface, or the adhesion of the coated surface to an uncoated surface of the extrusion coated paper when wound onto paper rolls, before cutting/forming into finished paper products. Blocking resistance can be tested using the I.C. Block tester, described by ASTM WK20008.

By way of non-limiting illustration, examples of certain embodiments of the present disclosure are given below.

### EXAMPLES

Aspects of the presently claimed invention are more fully illustrated by the following examples, which are set forth to illustrate certain aspects of the present invention and are not to be construed as limiting thereof.

### Materials:

The monomers abbreviations that were used in the aqueous compositions are as follows:
AA is an abbreviation for acrylic acid obtained from Aldrich Chemical Company;
BA is an abbreviation for n-butyl acrylate obtained from Aldrich Chemical Company;
MAA is an abbreviation for methacrylic acid obtained from Aldrich Chemical Company;
MMA is an abbreviation for methyl methacrylate obtained from Aldrich Chemical Company;
AMS is alpha-methylstyrene obtained from Aldrich Chemical Company;
2-EHA is an abbreviation for 2-ethylhexylacrylate obtained from Aldrich Chemical Company;
STY is an abbreviation for styrene obtained from Aldrich Chemical Company;
APS is an abbreviation for ammonium persulfate obtained from Aldrich Chemical Company; and
TBHP is an abbreviation for tert-butylhydroperoxide obtained from Aldrich Chemical Company.
Isoascorbic acid is obtained from Aldrich Chemical Company.
Filtrez™ 530 is an alcohol soluble fumaric acid modified rosin ester with a high softening point and high acid value, T_{g}=105.8° C.; acid number=195 mg KOH/gram: viscosity G (2.3 sec.), according to Gardner-Holdt, 60% NV Ethanol, 25° C.; Mn=656 Da.; Mw=2011 Da.; and PDI=3.07, available from Lawter.
Filtrez™ 531 is an alcohol soluble fumaric acid modified rosin ester with a high softening point and moderately high acid value, T_{g}=105° C.; acid number=176 mg KOH/gram: viscosity L (3.6 sec.), according to Gardner-Holdt, 60% NV Ethanol, 25° C.; Mn=746 Da.; Mw=3636 Da.; and PDI=4.87, available from Lawter.
Filtrez™ 3320 is a maleic modified rosin ester, Melting Point=123° C.; acid number=64 mg KOH/gram: viscosity D (1.4 sec., according to Gardner-Holdt, 60% NV Toluene, 25° C.): Mn=875 Da.; Mw=2516 Da.; and PDI=2.88, available from Lawter.
Filtrez™ 5014A is an alcohol soluble fumaric acid modified rosin ester, T_{g}=85° C.; acid number=175 mg KOH/gram: viscosity J (3.1 sec.), according to Gardner-Holdt, 60% NV Ethanol, 25° C.; Mn=760 Da.; Mw=6605 Da.; and PDI=8.69, available from Lawter.
Calfax DB 45 is C12 (branched) sodium diphenyl oxide disulfonate, available from Pilot.
Aerosol OT75 is sodium dioctyl sulfosuccinate solution, surfactant, available from Solvay.
Disponil AFX1080 is an alkylaryl polyglycolether sulphate, ammonium salt, emulsifier, available from BASF.

### Testing Methods:

Molecular weight determination: Gel permeation chromatography (GPC) spectra were acquired with a Waters 2695 instrument and were used to determine molecular weight of polymers using tetrahydrofuran (THF) as the mobile phase at 40° C. and a RI detector. All samples were analysed for number average molecular weight (Mn), weight average molecular weight (Mw), and polydispersity (PDI) using elution times calibrated against polystyrene molecular weight standards.

Solid content determination: The solid content of the dispersions was measured gravimetrically by drying about 0.5 g to about 2 g sample of dispersions in a 140° C. oven for 1 hour.

Viscosity determination: The viscosity was measured by a Brookfield LV at 20° C. to 25° C.

Particle size determination including volume average particle size: Particle size of the dispersions were measured using a nano-flex particle sizer from Microtrac.

Acid value determination: Acid value or number was measured by potentiometric titration according to ASTM D664-95.

Glass Transition Temperature determination: Glass transition temperature (T_{g}) was measured by differential scanning calorimetry (DSC) according to ASTM D3418-15.

Minimum Film Formation Temperature (MFFT) determination: The MFFT was measured according to ASTM D2354-10.

Block Resistance: Block resistance testing was measured according to ASTM WK20008. Block resistance tests were carried out to determine the resistance of the polymer binder to stick to itself and uncoated paper under pressure and at elevated temperatures. The tests measure the extent of tackiness and damage that a coated substrate experiences when subjected to standard temperature, pressure, and time. Rolls of coated paper stock can achieve an internal pressure of up to 60 psi, depending on paper uniformity. When stored or transported under tropical conditions (30° C. and 95% relative humidity), coated paper layers can stick together, and, in the worst-case scenario, the paper or coating can be significantly damaged. Block resistance tests were performed at 50° C. and 60 psi for 24 hours. Samples were cut 1×3 inches and two sheets were layered coating-to-paper (face-to-back, F-B) or coating-to-coating (face-to-face, F-F) in a block testing apparatus. A spring was then placed on top of the layers to apply a certain amount of pressure on the samples. The entire apparatus was placed in an oven capable of humid conditions at 50° C. for 24 hours. A Koehler Instrument K53000 I.C. block tester was used for this testing. When the block test was completed, the samples were removed and monitored for tack and damage of samples. The rating system is described below.

Rating system for block resistance tests.

| Rating | Explanation |
|---|---|
| 5- No Blocking | No adhesion or cohesion (no tack between the two |
| | sheets). Sheets slide or peel freely from one |
| | another with no paper substrate damage. |
| 4- Slight Cling | Slight ticking can be heard as the samples are |
| | peeled (slight tack between the two sheets). No |
| | visible distortion and no paper substrate damage. |
| 3- Cling | Noticeable adhesion between adjacent surfaces |
| | (significant tack between the two sheets) & |
| | visual distortion of the surfaces. No distortion |
| | of webs or offset printing inks or lacquers, no |
| | paper substrate damage. |
| 2- Slight Blocking | Slight adhesion. Adjacent surfaces do not separate |
| | freely, but will with frictional slide or peel |
| | pressure. Surface of specimen may show slight |
| | distortion. Less than 50% paper substrate damage. |
| 1- Considerable | Adhesion or cohesion of contiguous surfaces. |
| Blocking | Layers may be separated with difficulty. Surfaces |
| | will be distorted. More than 50% paper substrate |
| | damage. |
| 0- Complete | Blocking to the extent of a complete seal or weld |
| Blocking | between adjacent surfaces which cannot be |
| | separated without destruction of the test specimen. |

Cobb Testing. Cobb testing was measured according to TAPPI T 441 (2001). This method describes a procedure for determining the quantity of water absorbed by nonbibulous paper, paperboard and corrugated fiberboard in a specified time under standardized conditions. It is based on studies by Cobb and Lowe, Cobb and other investigators. Water absorptiveness is a function of various characteristics of paper or board such as sizing, porosity, etc. This method is generally applicable to sized paper, paperboard and corrugated fiberboard. To perform adequate testing, five (8.5″×11″) sheets are used. Generally, five replicates of the paper are tested.

Heat Seal Testing. Heat Seal Testing was measured according to ASTM F2029. A semi-automatic heat sealer was used to seal samples according to ASTM F2029 at certain temperatures, pressures, and sealing times (e.g., 1 second dwell time, 40 psi, 125-250° C.). Hot Tack Peel Strength Tester is used to determine hot tack property test for plastic films, laminated films and other packaging films. Meanwhile, it is also used for peel, shear, tension and other test items for adhesives and laminated films.

### Example 1: Synthesis of Polymeric Resin Dispersion Containing Thirty-Five Percent Fumaric Acid Modified Rosin Ester Content Using One Monomer Feed

To a reaction vessel equipped with a condenser, thermometer, nitrogen inlet, and an overhead stirrer, deionized water (90.8 grams), Calfax DB45 (1.25 grams, 45% solids) and fumaric acid modified rosin ester dispersion (Filtrez 531, 506.5 grams, 28% solids) were added and heated to 70° C. under a stream of nitrogen. Isoascorbic acid (2.26 grams), ammonium hydroxide (1.12 grams, 29%) and deionized water (27.74 grams) were added and held for 2-3 minutes with agitation. Copper sulfate (0.02 grams) and deionized water (8.56 grams) were added and held for 3-5 minutes with agitation. The monomer feed mixture (methyl methacrylate MMA, 55.94 grams; n-butylacrylate BA, 128.13 grams; Aerosol OT75, 4.62 grams (75% solids); and 2-ethylhexyl acrylate 2-EHA, 82.05 grams) was added over 100 minutes, followed by a flush with 2.85 grams of deionized water. The initiator feed (tertiary-butylhydroperoxide (3.37 grams, 70 wt. %) in 43.81 grams deionized water) was started simultaneously with the monomer feed and continued for 100 minutes, followed by a 30-minute hold. Two separate solutions (sodium erythorbate, 19.27 grams, 12% solids in 1.5 g deionized water) and (tertiary-butylhydroperoxide, 1.41 grams, 70 wt. %, in 8.46 grams deionized water) were added simultaneously over 60 minutes, followed by a 30-minute hold. The reaction mass was cooled to 30° C. and filtered. The desired aqueous polymeric resin dispersion containing 35% fumaric acid-modified rosin ester content was obtained with the following properties: solids=39.9 wt. %: T_{g}=−26° C.; pH=8.6: particle size (volume average diameter, dv)=222 nm: Mn=23.82 kDa Mw=69.72 kDa, PDI=2.97: viscosity=28 cPs.

### Example 2: Synthesis of Polymeric Resin Dispersions Containing Varying Levels of Fumaric Acid Modified Rosin Ester Content Using One Monomer Feed

Following the synthetic procedure of Example 1, six different example aqueous polymeric resin dispersions containing various levels of fumaric acid modified rosin ester content were synthesized. The properties are shown below in Table 1.

TABLE 1

| Property | Run 2 | Run 3 | Run 4 | Run 5 | Run 6 | Run 7 |
|---|---|---|---|---|---|---|
| Fumaric Acid | 25 | 30 | 40 | 45 | 50 | 60 |
| Modified Rosin | | | | | | |
| Content (wt %) | | | | | | |
| pH | 8.8 | 8.9 | 8.8 | 8.8 | 8.5 | 8.6 |
| Dv (nm) | 207 | 178 | 195 | 192 | 176 | 170 |
| Tg (C.) | −25 | −26 | −25 | −24 | −25 | −23 |
| Solids (%) | 40.1 | 41 | 39.8 | 39.3 | 37 | 35 |
| Mn, kDa | 36.15 | ND* | 22.31 | ND | 12.84 | 4.86 |
| Mw, kDa | 140.88 | ND | 66.08 | ND | 39.82 | 26.51 |
| PDI | 3.90 | ND | 2.84 | ND | 3.35 | 5.45 |
| Viscosity, cPs | 39 | 47 | 31 | 26 | 30 | 21 |

*ND = not determined

### Example 3: Synthesis of Polymeric Resin Dispersion Containing Thirty-Five Percent Fumaric Acid Modified Rosin Ester Content Using Two Monomer Feeds

To a reaction vessel equipped with a condenser, thermometer, nitrogen inlet, and an overhead stirrer, deionized water (90.8 grams), Calfax DB45 (1.25 grams, 45% solids) and fumaric acid modified rosin ester dispersion (Filtrez 531, 503 grams, 28% solids) were added and heated to 70° C. under a stream of nitrogen. Isoascorbic acid (2.19 grams), ammonium hydroxide (1.04 grams, 29%) and deionized water (26.06 grams) were added and held for 3 minutes with agitation. Copper sulfate (0.02 grams) and deionized water (8.56 grams) were added and held for 3 minutes with agitation. The first monomer mixture (methyl methacrylate MMA, 31.66 grams; n-butylacrylate BA, 62.52 grams; Aerosol OT75, 2.28 grams (75% solids); and 2-ethylhexyl acrylate 2-EHA, 37.73 grams) were added over 50 minutes. After the first addition, the second monomer mixture (methyl methacrylate MMA, 84.42 grams; n-butylacrylate BA, 34.3 grams; Aerosol OT75, 2.28 grams (75% solids); and 2-ethylhexyl acrylate 2-EHA, 13.19 grams) was added over 50 minutes, followed by a 4.5 grams deionized water flush. The initiator feed (tertiary-butylhydroperoxide (3.28 grams, 70 wt %) in 42.7 grams deionized water) was started simultaneously with the monomer feeds and continued for 100 minutes, followed by a 30-minute hold with agitation during post polymerization. Two separate solutions (sodium erythorbate 19.27 grams (12% solids) in 1.5 grams deionized water) and (tertiary-butylhydroperoxide (1.41 grams, 70 wt. %) in 8.43 grams deionized water 8.43 grams) were added simultaneously over 60 minutes, followed by a 30-minute hold. The reaction was cooled to 30° C. and filtered. The desired aqueous polymeric resin dispersion containing 35% fumaric acid-modified rosin ester content was obtained with the following properties: solids=40 wt. %: T_{g}=6 C: pH=8.7: particle size (volume average diameter, dv)=225 nm; Mn=28.65 kDa Mw=84.48 kDa, PDI=2.95; viscosity=34 cPs.

### Example 4: Synthesis of Polymeric Resin Dispersion Containing Forty Percent Fumaric Acid Modified Rosin Ester Content using two Monomer Feeds

Following the procedure of Example 3, the desired polymeric resin dispersion containing 40% fumaric acid-modified rosin ester content was obtained with the following properties: solids=39.8 wt. %: T_{g}=5 C: pH=8.6; particle size (volume average diameter, dv)=180 nm; Mn=24.22 kDa Mw=73.12 kDa: PDI=3.02: viscosity=29 cPs.

### Example 5: Redox Initiator Compared to Ammonium Persulfate Initiator

Three emulsions were prepared using varied amounts of rosin and different initiators, either tert-butylhydroperoxide as a redox initiator or ammonium persulfate (APS) as a thermal initiator as described further below in Comparative Example 2. The emulsions were treated at different temperatures depending upon the initiator used. When using the thermal initiator, the reaction was warmed to 85° C. When using a redox initiator, the reaction was conducted at 70° C. The percent conversion over time was measured and is shown in Table 2. As shown therein, both preparations using the redox initiator attained nearly complete conversion, while the preparation using APS reacted more slowly and did not reach 100% conversion.

TABLE 2

| Reaction Time | Comparative Ex 2 | Ex 2 Run 2 | Ex 2 Run 7 |
|---|---|---|---|
| (minutes) | APS (85° C.) | Redox (70° C.) | Redox (70° C.) |
| 0 | 0 | 0 | 0 |
| 20 | 39 | 85 | 73 |
| 40 | 44 | 82 | 78 |
| 60 | 52 | 90 | 85 |
| 80 | 58 | 91 | 86 |
| 90 | 67 | 95 | 92 |
| 100 | 75 | 96.6 | 95.8 |
| 120 | 85 | 97.5 | 96 |
| 130 | 89 | 98 | 95 |
| 140 | 92 | 98.5 | 97.9 |
| 150 | 92.3 | 98.8 | 98.3 |
| 180 | 93.1 | 98.7 | 98.1 |

### Example 6: Water Uptake and Block Resistance as a Function of Rosin Percentage

Eight emulsion formulations were tested for efficacy. The comparative example contains styrene while the remaining examples are free of styrene. Specifically, water uptake and block resistance were tested for the formulations with varying amounts of rosin ester, with the results shown in Table 3.

TABLE 3

| Fumaric Acid | | Number of | | |
|---|---|---|---|---|
| Modified Rosin | | Monomer | | Block |
| Content (wt %) | Example | Feeds | Cobb (g/m²) | Resistance |
| 0; styrene | Comparative | 1 | 14.5 | 4 |
| monomer | Ex 1 | | | |
| 25 | Ex 2 Run 2 | 1 | 13.5 | 1 |
| 35 | Example 1 | 1 | 41 | 3 |
| 35 | Example 3 | 2 | 15 | 4 |
| 40 | Ex 2 Run 4 | 1 | 52 | 4 |
| 40 | Example 4 | 2 | 25 | 4 |
| 50 | Ex 2 Run 6 | 1 | 70 | 4 |
| 60 | Ex 2 Run 7 | 1 | 69 | 4 |

As shown, the formulations comprising the monomer of Feed 1 and Feed 2, along with 35 or 40% rosin, respectively, displayed favorable results for water uptake and comparable results for blocking resistance.

### Example 7: Water Uptake and Block Resistance of Coatings

Two different styrene-free emulsions were formulated using a rosin ester (35%). The multilayer particles displayed a T_{g} of 5-7° C. The hydrophobic monomers used were methyl methacrylate, n-butyl acrylate, and 2-ethylhexyl acrylate at a weight ratio of 1:1.97:1.19. The ratio of monomers was 50:50 Feed 1 to Feed 2. The initiator used was a redox initiator comprising tert-butylhydroperoxide (TBHP) and ascorbic acid. The polymerization temperature was 70° C. One emulsion included acrylic acid (AA) as a functional monomer (Rosin Emulsion 1), while the other was prepared without the functional monomer (Rosin Emulsion 2). The emulsions were tested against a standard emulsion on both SBS Board and CIS Board to determine water uptake and block resistance. The characteristics of the tested emulsions are shown below in Table 4.

TABLE 4

| | Biorenewable | Solid | | Viscosity, | |
|---|---|---|---|---|---|
| Emulsion Type | content (%) | (%) | pH | cps | Dv (nm) |
| Comparative Ex. 1 | 0 | 48 | 7.9 | 1150 | 81 |
| Rosin Emulsion 1 | 35 | 45 | 8.5 | 256 | 452 |
| Rosin Emulsion 2 | 35 | 45 | 8.6 | 178 | 366 |

The board was coated using either a rod coating application or a Flexo Anilox application. For rod coating, a 1/0 rod was used with a loading of 5-8 g/m². The coating was dried for 1 minute at 60° C., then conditions for 1-4 days at 25° C. at 50% relative humidity. The Cobb test was conducted at room temperature for 30 minutes. The block resistance test was conducted over 24 hours at 50° C. under 60 pounds of force (coating to coating and coating to substrate).

For the Flexo Anilox application, the anilox used was a 2×120 Lpi anilox, with a loading of 6-7 g/m². The flexo plate was dried for 1 minute at 80° C., then conditioned for 1-4 days at 25° C. and 50% relative humidity. The Cobb test was conducted at room temperature for 20 minutes, and the blocking resistance test was conducted as described for the rod coating application.

The water uptake and blocking resistance of SBS alone, as well as CIS alone, were tested against rod- or flexo-coated boards using the formulations described above. Permeance and Cobb values are shown below in Table 5 for Rosin Emulsions 1 and 2 as well as the standard, along with the paper board used and coating method.

TABLE 5

| | Application | | Permeance | Cobb |
|---|---|---|---|---|
| Formulation | Method | Paper Stock | mL/min | g/m² |
| Rosin Emulsion 1 | Rod 1-0 | SBS | 0.56 | 10 |
| Rosin Emulsion 2 | Rod 1-0 | SBS | 0.59 | 9 |
| Comparative Ex. 1 | Rod 1-0 | SBS | 0.45 | 20 |
| Rosin Emulsion 1 | Flexo 120 × 2 | SBS | 1.71 | 20 |
| Rosin Emulsion 2 | Flexo 120 × 2 | SBS | 1.1 | 26 |
| Comparative Ex. 1 | Flexo 120 × 2 | SBS | 0.91 | 22 |
| Rosin Emulsion 1 | Flexo 120 × 2 | C1S | 0.56 | 4 |
| Rosin Emulsion 2 | Flexo 120 × 2 | C1S | 0.57 | 7 |
| Comparative Ex. 1 | Flexo 120 × 2 | C1S | 0.52 | 9 |

As shown in Table 5, the emulsions of the present disclosure either match or improve upon currently available emulsions.

### Example 8: Surface Tension

The two Rosin Emulsions were then tested against a standard to determine total surface energy of the coatings on SBS paper board, applied either using the rod coating or flexo methods described above. The results are shown below in Table 6. As a reference, the surface tension of water is 72.8 mN/m (milliNewton/meter) while the surface tension of the Comparative Ex. 1 is 41.7 mN/m and rosin emulsions 1 and 2 are about 34.5 mN/m.

TABLE 6

| | Total Surface Energy | Total Surface Energy |
|---|---|---|
| Formulation | mN/m Rod Coating | mN/m Flexo |
| Comp. Ex. 1 | 29 ± 2.4 | 26 ± 1.2 |
| Rosin Emulsion 1 | 29 ± 0.4 | 29 ± 1.2 |
| Rosin Emulsion 2 | 30 ± 1.6 | 28 ± 0.7 |

### Example 9: Hydrolytic Stability

Two emulsion preparations were tested for hydrolytic stability at 50° C. Stability was determined by determining both acid value and molecular weight following the indicated storage period. The results are shown in Table 7 below.

TABLE 7

| | Acid Value mg KOH/g | | | Mw (kDa) | | |
|---|---|---|---|---|---|---|
| Formulation | Initial | 2 weeks | 4 weeks | Initial | 2 weeks | 4 weeks |
| Rosin Emulsion 1 | 99 | 94 | 96 | 84.3 | 83.3 | 85.4 |
| pH 8.7 | | | | | | |
| Rosin Emulsion 2 | 93 | 90 | 92 | 96.9 | 96.6 | 92.3 |
| pH 9.0 | | | | | | |

### Example 10: Hydrolytic Stability at 50° C. Storage

Different aqueous polymeric resins of the instant invention were tested for hydrolytic stability at 50° C. Stability was determined by examination of sedimentation, phase separation, and coagulation following the indicated storage period. The results are shown in Table 8 below, wherein grit % was determined at the end of polymerization process as opposed to the end of the storage period. Regarding storage stability, a good/stable rating indicates no coagulation, no phase separation, and no sedimentation.

TABLE 8

| | # of | | | Dv | Tg ° C. | | Storage Stability |
|---|---|---|---|---|---|---|---|
| Sample | Monomer Feeds | Solid % | pH | (nm) | (DSC) | Grit % | (2 weeks/50° C.) |
| Comp Ex. 1 | 1 | 48% | 7.9 | 81 | −27 | <0.01% | Good/Stable |
| Comp. Ex. 2 | 1 | 34.6 | 8.3 | 1851 | −26 | ~1% | Paste/Unstable |
| Ex. 2 Run 2 | 1 | 41 | 8.8 | 207 | −25 | <0.01% | Good/Stable |
| Example 1 | 1 | 40 | 8.6 | 222 | −26 | <0.01% | Good/Stable |
| Ex. 2 Run 4 | 1 | 38 | 8.8 | 193 | −24 | <0.01% | Good/Stable |
| Ex. 2 Run 6 | 1 | 37 | 8.5 | 176 | −25 | <0.01% | Good/Stable |
| Ex. 2 Run 7 | 1 | 35 | 8.6 | 170 | −23 | <0.01% | Good/Stable |
| Example 3 | 2 | 40 | 8.7 | 225 | 6 | <0.01% | Good/Stable |
| Example 4 | 2 | 40 | 8.6 | 180 | 5 | <0.01% | Good/Stable |

### Example 11: Heat Seal Testing

Heat Seal Testing was measured according to ASTM F2029. Heat seal testing of Rosin Emulsion 2 was conducted at different temperatures (140° C. to 240° C.) with a double layer of coating, with a theoretical coat weight of 5-6 gsm (grams per square meter) applied on CIS paper. The emulsion exhibited excellent heat seal performance, outperforming Comparative Example 1 as shown in Table 9.

TABLE 9

| | | | Average |
|---|---|---|---|
| Sample | Temperature (° C.) | X | (Newtons) |
| Comparative | 140 | Face-To-Face | 15.4 |
| Example 1 | | Face-to-Stock | 12.1 |
| | 160 | Face-To-Face | 17.1 |
| | | Face-to-Stock | 16.3 |
| | 180 | Face-To-Face | 15.3 |
| | | Face-to-Stock | 16.9 |
| | 200 | Face-To-Face | 15.7 |
| | | Face-to-Stock | 15.1 |
| | 220 | Face-To-Face | 14.6 |
| | | Face-to-Stock | 15.4 |
| | 240 | Face-To-Face | 16 |
| | | Face-to-Stock | 16.5 |
| Rosin Emulsion- | 140 | Face-To-Face | 16.4 |
| 2 | | Face-to-Stock | 17.2 |
| | 160 | Face-To-Face | 20.3 |
| | | Face-to-Stock | 18.9 |
| | 180 | Face-To-Face | 20.5 |
| | | Face-to-Stock | 17.9 |
| | 200 | Face-To-Face | 23.4 |
| | | Face-to-Stock | 13.7 |
| | 220 | Face-To-Face | 17.3 |
| | | Face-to-Stock | 11.9 |
| | 240 | Face-To-Face | 16.6 |
| | | Face-to-Stock | 12.3 |

### Example 12: Synthesis of Polymeric Resin Dispersion Containing Thirty Five Percent Fumaric Acid Modified Rosin Ester Content Using Two Monomer Feeds

To a reaction vessel equipped with a condenser, thermometer, nitrogen inlet, and an overhead stirrer, deionized water (18 grams), Disponil AFX 1080 (2.55 grams, 80% solids) and fumaric acid modified rosin ester dispersion (Filtrez. 5014A, 545 grams, 28.2% solids) were added and heated to 70° C. under a stream of nitrogen. Isoascorbic acid (2.45 grams), ammonium hydroxide (1.12 grams, 29%) and deionized water (23.01 grams) were added and held for 3 minutes with agitation. Copper sulfate (0.03 grams) and deionized water (2.85 grams) were added and held for 3 minutes with agitation. The first monomer mixture (methyl methacrylate MMA, 35.3 grams; n-butylacrylate BA, 64.89 grams; acrylic acid, 1.86 grams; Aerosol OT75, 2.29 grams, (75% solids); and 2-ethylhexyl acrylate 2-EHA, 40.88 grams) were added over 50 minutes. The second monomer mixture (methyl methacrylate MMA, 89.3 grams; n-butylacrylate BA, 37.45 grams; acrylic acid, 1.86 grams; Aerosol OT75, 2.29 grams (75% solids); and 2-ethylhexyl acrylate 2-EHA, 14.3 grams) was then added over 50 minutes, followed by a 4.5 gram deionized water flush. The initiator feed (tertiary-butylhydroperoxide, 3.61 grams, 70 wt. %, in 46.93 grams deionized water) was started simultaneously with the monomer feeds and continued for 100 minutes, followed by a 30-minute hold with agitation during post polymerization. Two separate solutions (sodium erythorbate, 19.27 grams, 12% solids in 1.5 grams deionized water) and (tertiary-butylhydroperoxide, 2.97 grams, 70 wt. %, in 17.83 grams deionized water) were added simultaneously over 30 minutes followed by a 30-minute hold. The reaction was cooled to 30° C. and filtered. The desired aqueous polymeric resin dispersion containing 35% fumaric acid-modified rosin ester content was obtained with the following properties: solids=45.7 wt. %: T_{g}=5 C: pH=8.13: particle size (volume average diameter, dv)=159 nm: Mn=23.85 kDa, Mw=20) 135.26 kDa, PDI=5.67: viscosity=58.50 cPs.

### Comparative Example 1: Synthesis of Acrylic Emulsion Polymer Comprising a Partially Neutralized, Acid-Functional Support Resin

The acid-functional polymer described below was prepared via a high temperature, continuous polymerization process as described in U.S. Pat. Nos. 5,461,60, 4,414,370, and 4,529,787, all of which are incorporated herein by reference. The polymer was made using a continuous free radical polymerization process at relatively high temperatures in a homogenous environment. High reaction temperatures generate low molecular weight polymers without the use of chain transfer agents. After the polymerization step, the resin was passed to a devolatilizer to remove unreacted monomers and process solvents. Using the above procedure, a polymer (an acid-functional polymeric resin) was made from 30 wt. % alpha-methyl styrene, 33 wt. % styrene, 6 wt. % 2-ethylhexylacrylate, and 31 wt. % acrylic acid with the following properties: T_{g}=141° C.; acid number=227 mg KOH/gram: Mn=3.4 kDa: PDI=2.88; and Mw=9.75 kDa.

The acid-functional polymer described above was dispersed in water by neutralizing a fraction of the acid groups with a base under agitation and heat. For example, an aqueous polymeric resin dispersion at 28.5 wt. % solids was prepared by adding 220 grams polymeric resin synthesized above to 473.7 grams deionized water and 50.3 grams ammonia (29 wt. % active) to a reaction vessel equipped with a condenser and an overhead stirrer. This mixture was heated to 88° C.-92° C. under agitation and kept for 4 hours, after which it was cooled to room temperature and filtered to provide the polymer dispersion with the following properties: polymer solids=28.5 wt. %: pH=8.0: viscosity=200 cPs; and particle size (volume average diameter, dv)=<10 nm.

Following the synthesis of the partially neutralized, acid-functional support resin described above, synthesis of the rheology controlled acrylic emulsion polymer was completed. To a reaction vessel equipped with a condenser, thermometer, nitrogen inlet, and an overhead stirrer, deionized water (31.1 grams) and the polymeric resin support dispersion described above (93.4 grams. 28.5% solids) were added and heated to 82° C. under a stream of nitrogen. Ammonium persulfate (0.66 grams) and deionized water (51.2 grams) were added and held for 3 minutes with agitation. The monomer mixture (methyl methacrylate, 17 grams; butylacrylate, 38.8 grams; and 2-ethylhexyl acrylate, 24.9 grams) was added over 90 minutes, followed by a 1.3 gram deionized water flush and a 30-minute hold. Tertiary-butylhydroperoxide (0.4 grams) and deionized water (2.38 grams) were added and held for 10 minutes. Sodium erythorbate (1.4 grams) and deionized water (3.2 grams) were added over 15 minutes and held for ten minutes. The reaction was cooled to ambient temperature and filtered. The desired polymeric resin emulsion was obtained with the following properties: viscosity at 25° C. is 1150 cps measured by a Brookfield LV, spindle #3 at 30 rpm. 30 seconds: solids are 48 wt. %: T_{g}=−27 C: MFFT=<5 C: acid number=64 mg KOH/gram: particle size (volume average diameter, dv)=81 nm; and Mw=826 kDa.

### Comparative Example 2. Synthesis of Polymeric Resin Dispersion Containing Twenty-Five Percent Fumaric Acid Modified Rosin Ester Content Using One Monomer Feed

To a reaction vessel equipped with a condenser, thermometer, nitrogen inlet, and an overhead stirrer, deionized water (319 grams). Disponil AFX1080 (2.5 grams. 80% solids) and fumaric acid modified rosin ester dispersion (Filtrez. 531, 313.8 grams. 28.3% solids) were added and heated to 85° C. under a stream of nitrogen. The first initiator (ammonium persulfate APS 100% (1.35 grams) and deionized water (12.15 grams)) were added and held for 3-5 minutes. The monomer mixture (methyl methacrylate MMA. 125.21 grams; n-butylacrylate BA. 79.5 grams; Aerosol OT75, 4.38 grams (75% solids); and 2-ethylhexyl acrylate 2-EHA. 58.13 grams) was added over the period of 120 minutes followed by 15 gram-deionized water flush. The initiator feed (ammonium persulfate APS 100% (1.35 grams) and deionized water (12.15 grams)) were started after 60 minutes of monomer feed and was continued for 60 minutes with agitation. At the end of the APS and monomer feeds, the reaction mixture was held for 30 minutes with agitation during post polymerization. Two separate solutions: sodium erythorbate, 19.27 grams, 12% solids; in 1.9 grams deionized water, and tertiary-butylhydroperoxide (2.97 grams, 70 wt %) in 17.83 grams of deionized water 17.83 grams were added simultaneously over 30 minutes followed by a 30-minute hold. The reaction was cooled to 30° C. and filtered. The desired polymeric resin dispersion containing 25% fumaric acid-modified rosin ester content is obtained with the following properties: solids=34.6 wt. %; T_{g}=−26 C; pH=8.3; particle size (volume average diameter, dv)=1851 nm; Mn=40.62 kDa, Mw=119.80 kDa; PDI=2.95; viscosity=16 cps.

1.-19. (canceled)

20. A method of making a polymer emulsion comprising:
i) providing a resin dispersion comprising at least one resin in an aqueous solution;
ii) adding at least one polymer seed and a polymerization mixture to the resin dispersion, the polymerization mixture comprising at least one co-polymerizable monomer; and
iii) preparing a polymer emulsion in water by radical emulsion polymerization of the polymerization mixture, the resin dispersion and the polymer seed.

21. The method of claim 20, wherein the at least one resin is derived from a biorenewable source.

22. The method of claim 20, wherein the at least one resin comprises a rosin ester.

23. The method of claim 20, wherein the at least one resin comprises a fumarate ester.

24. The method of claim 20, wherein the at least one resin has an acid value of from 125 mg KOH/g to 200 mg KOH/g.

25. The method of claim 20, wherein the at least one resin has a number average molecular weight (Mn) of from 600 g/mol to 800 g/mol, and a weight average molecular weight (Mw) of from 1500 g/mol to 15,000 g/mol.

26. The method of claim 20, wherein the emulsion polymerization monomers are added as two separate feeds, Feed 1 and Feed 2.

27. The method of claim 26, wherein the T_{g} of Feed 1 is from −25° C. to −15° C., as measured by ASTM D3418-15.

28. The method of claim 26, wherein the T_{g} of Feed 2 is from 20° C. to 40° C., as measured by ASTM D3418-15.

29. The method of claim 20, wherein the monomers are selected from the group consisting of methyl (meth)acrylate, n-butyl (meth)acrylate, t-butyl (meth)acrylate, i-butyl (meth)acrylate, 2-ethylhexyl (meth)acrylate, (meth)acrylic acid, itaconic acid, and combinations thereof.

30. The method of claim 20, further comprising an initiator.

31. The method of claim 30, wherein the initiator is a redox initiator.

32. The method of claim 30, wherein the initiator is selected from the group consisting of isoascorbic acid (IAA), t-butyl hydroperoxide (TBHP), and a combination thereof.

33. The method of claim 20, further comprising a catalyst.

34. The method of claim 33, wherein the catalyst comprises copper (II) sulfate (CuSO₄).

35. A polymer emulsion obtained by the method according to claim 20, wherein the polymer emulsion is substantially free of styrene.

36. An aqueous composition comprising the polymer emulsion of claim 20.

37. A coating, comprising the aqueous composition of claim 36 and a substrate.

38. The coating of claim 37, wherein the substrate is selected from the group consisting of paper, paperboard, and cardboard.
